(19) United States
(12) Patent Application Publication
(10) Pub. No.: US 2025/0116378 A1
(43) Pub. Date: Apr. 10, 2025

(54) CRYOGEN SUPPLY SYSTEM

(71) Applicant: Linde GmbH, Pullach (DE)

(72) Inventors: Anton WELLENHOFER, Pullach (DE); Eva MÜLLER, Pullach (DE); Stefan FELBINGER, Pullach (DE); Clemens WOLFERSTETTER, Pullach (DE); Christian ZACH, Pullach (DE); Harald ZENZ, Pullach (DE); Kathrin WELLENHOFER, Pullach (DE); Nabeel HAKEMI, Pullach (DE); Petya TONEVA, Pullach (DE); Johannes SCHAFRANEK, Pullach (DE)

(21) Appl. No.: 18/729,062

(22) PCT Filed: Jan. 11, 2023
(86) PCT No.: PCT/EP2023/025006

§ 371 Date: Jul. 15, 2024

(30) Foreign Application Priority Data
Jan. 20, 2022 (EP) 22020018.2

(51) Int. Cl. F17C 13/02; G01K 1/143; G01K 13/02

(52) U.S. Cl. CPC F17C 13/026; G01K 1/143; G01K 13/026; F17C 2205/0355; F17C 2223/0161; F17C 2250/0439

(57) ABSTRACT

A cryogen supply system for supplying a consumer with a cryogen, comprising a process pipe through which the cryogen can be conducted, a protective barrier, in which the process pipe is received, a gap, which is provided between the process pipe and the protective barrier, a heat conduction device, which is arranged in the gap and which is designed to transfer heat from the process pipe to the protective barrier or vice versa, and a temperature sensor arranged outside the protective barrier for detecting a temperature of the cryogen, the temperature sensor being thermally coupled to the heat conduction device.

The invention relates to a cryogen supply system for supplying a consumer with a cryogen.

In cryogenic operation of liquefied media, it is often necessary to measure a process temperature of a respective medium, especially a cryogen, in containers or pipes. According to internal company knowledge, this temperature measurement can be carried out using a temperature sensor that is mechanically and thermally connected directly to a process pipe. Direct measurements are difficult to achieve, especially at higher pressures. If the process pipe is encased in pressure-tight insulating pipes for good thermal insulation, it is undesirable from a safety and operational point of view to break through the insulating pipes with feedthroughs for cabling or for the temperature sensor. Breaking through the insulating tubes can lead to a loss of vacuum in the respective insulating pipe. This in turn can lead to a loss of insulating effect and failure of the affected region. Finding leaks and repairing such a system is laborious and time-consuming. This must be improved.

Against this background, the object of the present invention is to provide an improved cryogen supply system.

Accordingly, a cryogen supply system for supplying a consumer with a cryogen is proposed. The cryogen supply system comprises a process pipe through which the cryogen can be conducted, a protective barrier, in which the process pipe is received, a gap, which is provided between the process pipe and the protective barrier, a heat conduction device, which is arranged in the gap and which is designed to transfer heat from the process pipe to the protective barrier or vice versa, and a temperature sensor arranged outside the protective barrier for detecting a temperature of the cryogen, the temperature sensor being thermally coupled to the heat conduction device.

Since the temperature sensor is arranged outside the protective barrier and the heat conduction device takes over the heat transfer from the process pipe to the protective barrier and vice versa, it is advantageously possible to dispense with breaking through the protective barrier for placing the temperature sensor.

The cryogen is preferably hydrogen. The terms, “cryogen” and “hydrogen,” are therefore interchangeable as desired. In principle, however, the cryogen may also be any other cryogen. Examples of cryogenic fluids or liquids, or cryogens for short, are, in addition to the aforementioned hydrogen, liquid helium, liquid nitrogen, or liquid oxygen. A “cryogen” is thus to be understood in particular as a liquid. The cryogen can therefore also be referred to as a cryogenic fluid. The cryogen can be vaporized and thus converted into a gaseous phase. After vaporization, the cryogen is a gas or can be referred to as gaseous or vaporized cryogen. The term “cryogen” can thus comprise both, namely the gas phase and the liquid phase. As mentioned before, the liquid phase can also be referred to as cryogenic fluid. The term “vaporized cryogen” here refers preferably only to the gas phase of the cryogen.

A gas zone and an underlying liquid zone are formed in the cryogen supply system after or during a cryogen filling operation. A phase boundary is provided between the gas zone and the liquid zone. After the filling operation, the cryogen thus preferably has two phases with different aggregate states, viz., liquid and gaseous. The liquid-state phase can transition into the gaseous phase, and vice versa. The liquid phase can be referred to as a liquid phase. The gaseous phase can be referred to as a gas phase. A purely liquid filling of the cryogen supply system is also possible.

The consumer is preferably a fuel cell. In the present case, a “fuel cell” is understood to mean a galvanic cell that converts into electrical energy the chemical reaction energy of a continuously supplied fuel—in the present case, hydrogen—and of an oxidant—in the present case, oxygen. The cryogen is supplied to the consumer itself in particular in gaseous form, with a defined supply pressure. This means that the cryogen is fully vaporized before the consumer or upstream from the consumer. For example, the cryogen is supplied to the consumer with a supply pressure of 1 to 2.5 bara and a temperature of +10 to +25° C. However, the supply pressure can also be up to 6 bara.

The cryogen supply system can also be referred to as a hydrogen supply system. The cryogen supply system is in particular a pipe for conveying or transporting the cryogen. Alternatively, the cryogen supply system can also be a storage vessel or storage tank for storing the cryogen. The cryogen supply system can therefore also be referred to as a cryogen supply pipe or a cryogen storage vessel. In the following it is assumed that the cryogen supply system is a pipe, in particular a cryogen supply pipe. The heat conduction device can also be referred to as a heat transfer device.

The process pipe is in particular in direct contact with the cryogen. In particular, this means that the cryogen is conducted through the process pipe. The cryogen supply system is assigned a central or symmetry axis, with respect to which the process pipe and the protective barrier can be constructed so as to be rotationally symmetrical. The protective barrier completely surrounds the process pipe in a peripheral direction. This means in particular that the protective barrier completely encloses the process pipe peripherally. The gap provided between the process pipe and the protective barrier can be filled at least in portions with a damping element or insulation element. The gap can also be subjected to a negative pressure or vacuum. The gap can also be filled with gas.

With the help of the heat conduction device, it is possible to transfer heat from the process pipe through which the cryogen flows to the protective barrier and vice versa. The temperature sensor itself is preferably in touching contact with the protective barrier. Thus, the heat transferred from the process pipe via the heat conduction device to the protective barrier can be transferred to the temperature sensor or vice versa. It is therefore possible to at least indirectly determine the temperature of the process pipe or the cryogen.

The fact that the temperature sensor is located “outside” the protective barrier means in particular that the temperature sensor is not placed inside the gap. In particular, the temperature sensor is placed outside the gap. The thermal coupling of the temperature sensor to the heat conduction device preferably takes place indirectly via the protective barrier arranged between the heat conduction device and the temperature sensor. Thus, the heat conduction device transfers heat to the protective barrier or vice versa, which barrier in turn transfers heat to the temperature sensor or vice versa. The temperature sensor can be called a temperature recording device. A plurality of temperature sensors can be provided.

According to one embodiment, the heat conduction device is connected to the process pipe and/or the protective barrier in a force-fitting, integral and/or form-fitting manner.

Preferably, the heat conduction device comprises an annular base element with a cylindrical outside and a cylindrical inside. In particular, the inside is connected to the process pipe in at least a thermally conductive manner. Accordingly, the outside is connected to the protective barrier in particular in at least a thermally conductive manner. A force-locking connection requires a normal force on the surfaces to be joined. Force-locking connections can be achieved by frictional locking. The displacement of the surfaces with respect to one another is prevented as long as a counterforce caused by the static friction is not exceeded. For example, the heat conduction device is pressed or shrunk onto the process pipe. Accordingly, the heat conduction device can be pressed into the protective barrier. Given integrally bonded connections, the connection partners are held together by atomic or molecular forces. Integral connections are non-releasable connections that can only be separated by destroying the connecting means and/or the connection partners. For example, the base element is glued, soldered, in particular brazed, and/or welded to the process pipe and/or the protective barrier. A form-fitting connection is produced by at least two connection partners engaging with each other or behind each other.

According to a further embodiment, the heat conduction device has a slot extending along a radial direction of the heat conduction device which completely breaks through the heat conduction device.

The heat conduction device is preferably assigned the previously mentioned axis of symmetry, with respect to which the heat conduction device is designed to be essentially rotationally symmetrical. The previously mentioned base element of the heat conduction device is also designed to be rotationally symmetrical to the axis of symmetry. The slot extends from the inside of the base element to the outside of the base element. The radial direction is oriented perpendicularly to the axis of symmetry and away from it. The heat conduction device or the base element thus has an annular geometry, which is, however, not closed but open. The provision of the slot makes it possible to elastically deform the heat conduction device and, for example, to expand or compress it in the radial direction. This can be advantageous when installing the heat conduction device.

According to a further embodiment, the heat conduction device is fluid-permeable or fluid-impermeable.

For example, the gap is filled with gas. In case the heat conduction device is fluid-permeable, the gas can pass through the heat conduction device. Holes, apertures or recesses can be provided for this purpose. This avoids dividing the gap into separate gas chambers or pressure chambers. In case the heat conduction device is fluid-impermeable, the gas cannot pass through the heat conduction device. This allows the gap to be divided into a plurality of gas chambers or pressure chambers.

According to a further embodiment, the heat conduction device has recesses which are designed as through holes or as blind holes.

The recesses are provided in particular in or on the base element. Accordingly, the base element comprises the recesses. The number of the recesses is freely selectable. The recesses can have any geometry in cross-section. For example, the recesses are circular or polygonal in cross-section. At the same time, recesses can be provided which are designed as through holes, as well as recesses which are designed as blind holes. With the help of the recesses, the thermal conductivity of the heat conduction device can be changed, in particular reduced, in regions. This is achieved by using the recesses to locally reduce the material thickness of the heat conduction device or the base element. This leads to a deterioration in heat conduction in the region of the respective recess. The recesses act as thermal insulation. In regions where there are no recesses, the thermal conductivity remains unchanged. These regions without recesses can therefore be used for targeted local heat conduction. The heat conduction device or the base element can thus have a spoked-wheel-shaped geometry. In the case that the recesses are through holes, the gas in the gap can flow through the recesses.

According to a further embodiment, the recesses are filled with a plastics material at least in part.

This further worsens the thermal conductivity of the heat conduction device in some regions. Polytetrafluoroethylene (PTFE), for example, can be used as a suitable plastics material. For example, the plastics material is provided in the form of plugs which are accommodated in the recesses. With the help of the plastics material, the recesses can be sealed in a fluid-tight manner in the event that they are designed as through holes.

According to a further embodiment, the recesses are arranged unevenly spaced from one another in a peripheral direction of the heat conduction device, so that at least one recess-free region is provided between two adjacent recesses.

In this case, “recess-free” means that no recesses are provided in the previously mentioned region. The region is therefore solid. This means that the region without recesses has an increased or improved thermal conductivity compared to the recesses. This makes it possible to conduct the heat specifically from the process pipe to the protective barrier, preferably only in a region where the temperature sensor contacts the protective barrier.

According to a further embodiment, the gap is filled with gas, in particular with helium.

In particular, the gas must be selected in such a way that it does not condense during operation of the cryogen supply system. When using the cryogen supply system in conjunction with hydrogen, helium is particularly suitable as a gas for filling the gap. Helium does not condense at the temperatures occurring in the case of liquid hydrogen. However, other suitable gases can also be used.

According to a further embodiment, the cryogen supply system further comprises a vacuum envelope in which the protective barrier is accommodated, and a gap which is provided between the protective barrier and the vacuum envelope.

The gap provided between the process pipe and the protective barrier can be referred to as the first gap. Accordingly, the gap provided between the protective barrier and the vacuum envelope can be referred to as the second gap. The vacuum envelope is particularly tubular. The vacuum envelope can therefore also be referred to as a vacuum pipe. The vacuum envelope completely surrounds the protective barrier peripherally, which barrier in turn completely surrounds the process pipe peripherally. In particular, this means that the cryogen supply system is three-layered, the process pipe forming an innermost or first layer or innermost or first envelope, the protective barrier forming a second layer or second envelope, and the vacuum envelope forming a third layer or third envelope. The process pipe, the protective barrier and/or the vacuum envelope may be made of a metal material such as an aluminum alloy or stainless steel.

According to a further embodiment, the temperature sensor is guided through the vacuum envelope and the gap to the protective barrier.

This makes it possible for the temperature sensor to contact the protective barrier directly. The temperature sensor is thus provided at least in portions in the second gap provided between the vacuum envelope and the protective barrier.

According to a further embodiment, the cryogen supply system further comprises a protective tube in which the temperature sensor is accommodated, the protective tube being led through the vacuum envelope and the gap to the protective barrier.

In particular, the protective tube is arranged perpendicularly to the axis of symmetry of the cryogen supply system. The protective tube may have a cover or closure on the end face which is in contact with the protective barrier. In this case, the temperature sensor contacts this cover or closure. Alternatively, the protective tube can also be connected directly to the protective barrier so that the temperature sensor housed in the protective tube directly contacts the protective barrier. In this case, the protective tube has no cover or closure.

According to a further embodiment, the protective tube is connected to the vacuum envelope in a fluid-tight manner.

In particular, the protective tube is integrally connected to the vacuum envelope. For example, the protective tube is soldered, in particular brazed, or welded into the vacuum envelope. The protective tube can also be integrally connected to the protective barrier.

According to a further embodiment, the heat conduction device comprises a heat conduction element for transferring heat from the process pipe to the protective barrier or vice versa.

The heat conduction element offers the possibility of concentrating the heat transfer locally. The heat conduction element can be cylindrical or rod-shaped. The heat conduction element can also be referred to as heat transfer rib. The heat conduction element can furthermore also be referred to as a heat transfer element.

According to a further embodiment, the heat conduction device has a base element which carries the heat conduction element, the thermal conductivity of a material from which the heat conduction element is made being greater than the thermal conductivity of a material from which the base element is made.

For example, the base element can be made of rust-resistant or stainless steel. In this case, the heat conduction element can be made of a copper alloy or an aluminum alloy, for example. A plurality of heat conduction elements can be provided. The number of heat conduction elements is basically freely selectable. For example, exactly one heat conduction element can be provided. However, two, three or more than three heat conduction elements can also be provided.

According to a further embodiment, the base element has a bore in which the heat conduction element is received, an axis of symmetry of the bore being oriented perpendicular to an axis of symmetry of the heat conduction device.

For example, the heat conduction element is pressed into the bore of the base element. The bore extends from the outside of the base element to the inside. The bore thus completely penetrates the base element when viewed along the radial direction.

In the present case, “a” is not necessarily to be understood as limiting to precisely one element. It is rather the case that several elements, such as two, three, or more, may also be provided. Any other number word used herein is also not to be understood as a limitation being given to precisely the number of elements mentioned. It is rather the case that, unless otherwise indicated, the number may deviate upwardly or downwardly.

Further possible implementations of the cryogen supply system also include not explicitly mentioned combinations of features or embodiments described above or below with respect to the embodiments. In this case, a person skilled in the art will also add individual aspects as improvements or additions to the respective basic form of the cryogen supply system.

Further advantageous embodiments and aspects of the cryogen supply system are the subject matter of the dependent claims and of the embodiments of the invention as described below. The cryogen supply system is explained below in more detail on the basis of preferred embodiments and with reference to the accompanying drawings.

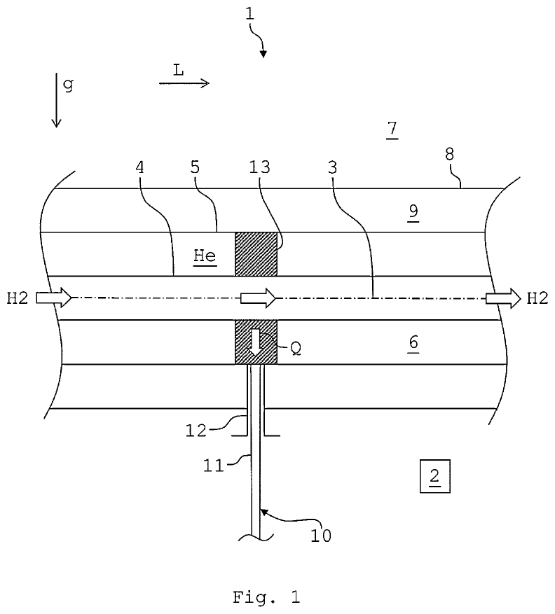

FIG. 1 is a schematic sectional view of an embodiment of a cryogen supply system;

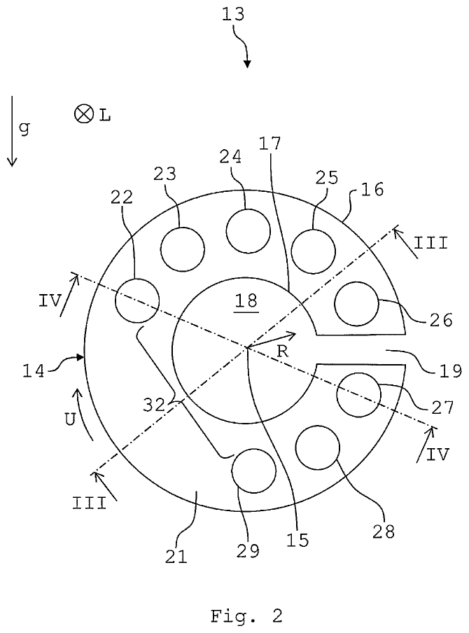

FIG. 2 is a schematic plan view of a heat conduction device for the cryogen supply system according to FIG. 1;

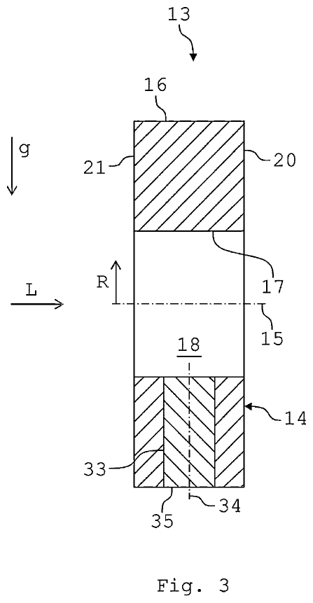

FIG. 3 is a schematic sectional view of the heat conduction device according to the cutting line III-III of FIG. 2; and

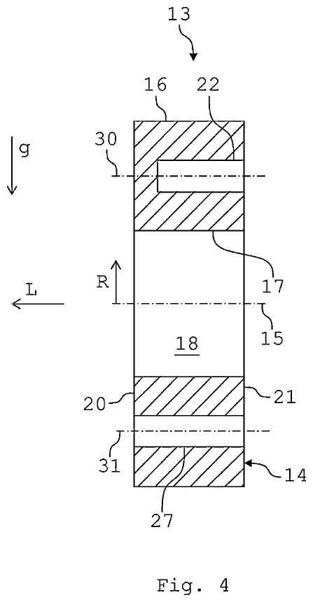

FIG. 4 is a further schematic sectional view of the heat conduction device according to the cutting line IV-IV in FIG. 2.

In the figures, the same or functionally equivalent elements have been provided with the same reference signs unless otherwise indicated.

FIG. 1 is a schematic sectional view of an embodiment of a cryogen supply system 1. The cryogen supply system 1 can be a pipe or a container. The cryogen supply system 1 is suitable for supplying a cryogen, in particular hydrogen H2, to a consumer 2, for example a fuel cell. The cryogen supply system 1 can therefore also be referred to as a hydrogen supply system.

Furthermore, the cryogen supply system 1 can also be suitable for storing hydrogen H2. The cryogen supply system 1 can be a storage vessel for storing hydrogen H2. However, the cryogen supply system 1 can also be a pipe for conveying or transporting hydrogen H2. In the following, it is assumed that the cryogen supply system 1 is a pipe or a transport line.

The cryogen supply system 1 is suitable for receiving and/or conveying liquid hydrogen H2 (boiling point 1 bara: 20.268 K=−252.882° C.). However, the cryogen supply system 1 can also be used for other cryogenic liquids or cryogens. Examples of cryogenic fluids or liquids, or cryogens for short, are liquid helium He in addition to the aforementioned liquid hydrogen H2 (boiling point 1 bara: 4.222 K=−268.928° C.), liquid nitrogen N2 (boiling point 1 bara: 77.35 K=−195.80° C.) or liquid oxygen O2 (boiling point 1 bara: 90.18 K=−182.97° C.).

The cryogen supply system 1 is suitable for use in or on a vehicle (not shown). The vehicle can be, for example, a maritime vessel, in particular a ship. The vehicle can be referred to as a maritime vehicle. In particular, the vehicle can be a maritime passenger ferry. Alternatively, the vehicle can also be a land vehicle. However, it is assumed below that the vehicle is a vessel.

In the present case, a “fuel cell” is understood to mean a galvanic cell that converts into electrical energy the chemical reaction energy of a continuously supplied fuel, in the present case hydrogen, and of an oxidant, in the present case oxygen. By means of the electrical energy obtained, an electric motor (not shown) can be powered, for example, which in turn drives a ship's screw for propelling the vehicle. The cryogen supply system 1 is intended to supply the consumer 2 with hydrogen H2.

The cryogen supply system 1 is suitable for providing the consumer 2, which in the present case is preferably a fuel cell, with gaseous hydrogen H2 at a defined supply pressure and a defined supply temperature. For example, the hydrogen H2 is supplied to the consumer 2 at a supply pressure of 1 to 2.5 bara and a temperature of +10 to +25° C. However, the supply pressure can also be up to 6 bara.

The cryogen supply system 1 is a pipe and can therefore also be referred to as a cryogen supply pipe. The cryogen supply system 1 is rotationally symmetrical with respect to a center axis or axis of symmetry 3. A longitudinal direction L of the cryogen supply system 1 is oriented along the axis of symmetry 3. The cryogen supply system 1 has a main pipe or process pipe 4 through which the liquid hydrogen H2 is conducted. The process pipe 4 is in direct contact with the liquid hydrogen H2. The process pipe 4 can be made of a metal material, in particular stainless steel.

The process pipe 4 is received in a tubular protective barrier 5 which peripherally encloses the process pipe 4. An intermediate space or gap 6 is provided between the process pipe 4 and the protective barrier 5. The gap 6 can be filled with an inert gas, for example nitrogen or helium He. The gap 6 can also be subjected to a negative pressure or a vacuum. In the vacuum, there is a negative pressure compared to an environment 7 of the cryogen supply system 1. A damping element or insulation element can be provided in the gap 6, which element fills the gap 6 at least in part or completely. The insulation element can have a multilayer insulation layer (MLI) or be designed as such. The protective barrier 5 can be made of a metal material, for example an aluminum alloy or stainless steel.

A tubular vacuum envelope 8 encloses the protective barrier 5. An intermediate space or gap 9 is provided between the protective barrier 5 and the vacuum envelope 8. The gap 9 can be subjected to a negative pressure or a vacuum. A damping element or insulation element can be provided in the gap 9, which element fills the gap 9 at least in part or completely. The insulating element may comprise a multilayer insulating layer as mentioned above or may be designed as such. The vacuum envelope 8 can be made of a metal material, for example an aluminum alloy or stainless steel. The vacuum envelope 8 separates the cryogen supply system 1 from the environment 7.

The cryogen supply system 1 further comprises a temperature measuring arrangement 10 which has a temperature sensor 11, with the aid of which a temperature of the liquid hydrogen H2 in the process pipe 4 can be acquired. In addition to the temperature sensor 11, the temperature measuring arrangement 10 has a protective tube 12 which is placed perpendicularly to the axis of symmetry 3. The temperature sensor 11 is housed in the protective tube 12.

The protective tube 12 is guided through the vacuum envelope 8 up to the protective barrier 5, so that the protective tube 12 rests against the protective barrier 5. The protective tube 12 thus extends through the gap 9. The protective tube 12 can be soldered or welded into the vacuum envelope 8. The protective tube 12 does not pass through the protective barrier 5. However, the protective tube 12 can be connected to the protective barrier 5 at the end face, for example soldered or welded thereto. The protective tube 12 is thus closed at the end face by the protective barrier 5. Alternatively, the protective tube 12 can be closed towards the protective barrier 5, in a fluid-tight manner, with a cover or the like. In the latter case, the cover can, for example, rest against the protective barrier 5. Viewed with respect to a direction of gravity g, the protective tube 12 is placed at a lowest point or region of the protective barrier 5.

The temperature measuring arrangement 10 further comprises a heat transfer device or heat conduction device 13 for transferring or conducting heat Q from the process pipe 4 to the protective barrier 5 and vice versa. Thus, the heat conduction device 13 is also suitable for transporting heat Q from the liquid hydrogen H2 flowing through the process pipe 4 to the temperature sensor 11 and vice versa. The heat conduction device 13 is envelope-shaped or ring-shaped and surrounds the process tube 4. The heat conduction device 13 can also be referred to as a heat conduction envelope or heat conduction ring. The heat conduction device 13 is placed in the gap 6. For example, the heat conduction device 13 is integrally connected to the process pipe 4 and to the protective barrier 5.

Given integrally bonded connections, the connection partners are held together by atomic or molecular forces. Bonded connections are non-releasable connections that can only be separated by destroying the connecting means and/or the connection partners. An integrally bonded connection can be effected, for example, by adhesive bonding, brazing, soldering, or welding. This means that the heat conduction device 13 is adhesively bonded, soldered, in particular brazed, and/or welded to the process pipe 4 and/or the protective barrier 5. Optionally or additionally, a force-locking connection and/or a form-locking connection can also be provided.

FIG. 2 is a schematic sectional view of an embodiment of a heat conduction device 13 as mentioned above. FIG. 3 is a further schematic sectional view of the heat conduction device 13 according to the cutting line III-III of FIG. 2. FIG. 4 is a further schematic sectional view of the heat conduction device 13 according to the cutting line IV-IV of FIG. 2. In the following, reference is made simultaneously to FIGS. 2 to 4.

The heat conduction device 13 comprises a base body or a base element 14. The base element 14 is ring-shaped or envelope-shaped and is designed to be rotationally symmetrical to a center axis or axis of symmetry 15. A cylindrical outside 16 of the base element 14 is thermally conductively coupled to the protective barrier 5. For example, the outside 16 is integrally connected to the protective barrier 5. The outside 16 is rotationally symmetrical in relation to axis of symmetry 15. The axes of symmetry 3, 15 can be arranged coaxially to one another.

Facing away from the outside 16, the base element 14 has a cylindrical inside 17 which delimits an aperture 18 which penetrates the heat conduction device 13 in the middle. The process pipe 4 is passed through the aperture 18. The inside 17 is thermally-conductively coupled to the process pipe 4. For example, the inside 17 is integrally connected to the process pipe 4. The inside 17 is designed to be rotationally symmetrical to the axis of symmetry 15.

Viewed along a peripheral direction U, which is oriented along the outside 16 or along the inside 17, the heat conduction device 13 or the base element 14 is not annularly closed, but rather open, and has a gap or slot 19 which, viewed along a radial direction R, which is oriented perpendicularly to the axis of symmetry 15 and away from it, extends from the inside 17 to the outside 16 and thus completely breaks through the base element 14.

The heat conduction device 13 or the base element 14 comprises a first end face 20 and a second end face 21 facing away from the first end face 20. A plurality of recesses 22 to 29 extend from at least one end face 20, 21 into or through the base element 14. The recesses 22 to 29 can be designed as blind holes, as shown in FIG. 4 with reference to the recess 22. Alternatively, the recesses 22 to 29 may be through holes, as shown in FIG. 4 with reference to the recess 27. Each recess 22 to 29 is assigned a center axis or axis of symmetry 30, 31 which is arranged parallel to the axis of symmetry 15 and spaced apart from it along the radial direction R.

With the help of the recesses 22 to 29, it is possible to design the heat conduction device 13 in such a way that as little material as possible is arranged between the inside 17 and the outside 16. The recesses 22 to 29 hinder the transport of heat Q from the inside 17 to the outside 16 and vice versa. A region 32 between the recesses 22, 29 is free of bores or recesses or is solid. This means that no recesses 22 to 29 are provided in the region 32. As a result, the heat conduction in the region 32 is improved compared to the recesses 22 to 29.

In the event that the recesses 22 to 29 are designed as through holes, it is possible that a gas received in the gap 6, for example helium He, can flow through the heat conduction device 13. The heat conduction device 13 is thus fluid-permeable. The heat conduction device 13 can be designed, for example, as a fluid-permeable spoked wheel. However, this is not mandatory. This means that the heat conduction device 13 can also be fluid-tight.

The recesses 22 to 29 can be filled with a material that is a poor heat conductor, such as a plastics material. Polytetrafluoroethylene (PTFE) can be used as the plastics material. The plastics material may be in the form of plugs closing the recesses 22 to 29. If the recesses 22 to 29 are filled with the plastics material, the gas accommodated in the gap 6, in particular helium He, can be prevented from flowing through the heat conduction device 13. Alternatively, the recesses 22 to 29 are designed as blind holes. Due to the fluid tightness of the heat conduction device 13, a local convective transfer of heat Q through the gas, in particular helium He, accommodated in the gap 6 can be avoided or at least reduced.

The base element 14 has a bore 33 having a center axis or axis of symmetry 34 which is oriented perpendicularly to the axis of symmetry 15. The bore 33 extends from the outside 16 towards the inside 17. The bore 33 penetrates both the outside 16 and the inside 17. A heat conduction element 35 is accommodated in the bore 33. The heat conduction element 35 can also be referred to as a heat conduction rib.

The heat conduction element 35 is cylindrical. The heat conduction element 35 can be pressed into the bore 33. The heat conduction element 35 contacts both the process pipe 4 and the protective barrier 5 and thus serves to transfer heat Q from the process pipe 4 to the protective barrier 5 and vice versa. More than one heat conduction element 35 may be provided. The heat conduction element 35 is arranged in the region 32.

The heat conduction element 35 can also be referred to as a heat transfer element, heat conduction body, heat conduction insert or conduction body insert. The heat conduction element 35 is made of a material that has better thermal conductivity than the material from which the base element 14 is made. For example, the heat conduction element 35 is made of a copper alloy or an aluminum alloy. The base element 14 itself can, for example, be made of stainless steel, which has a lower thermal conductivity than the material used for the base element 14. The base element 14 can also be made of a plastics material, in particular one that is free from degassing.

The heat conduction then takes place from the hydrogen H2 to the process tube 4, from the process tube 4 to the heat conduction element 35, from the heat conduction element 35 to the protective barrier 5, and from the protective barrier 5, optionally with the interposition of the protective tube 12, to the temperature sensor 11, or vice versa. In the event that the heat conduction device 13 does not have a heat conduction element 35, the base element 14 itself takes over the heat transfer.

With the aid of the heat conduction device 13, it is thus possible to carry out a temperature measurement which, from a process engineering point of view, reacts sufficiently quickly and at the same time allows as little heat conduction as possible. The protective barrier 5 is advantageously not penetrated or damaged for temperature measurement. Advantageously, the heat conduction device 13 does not lead to a segmentation of the gap 6. This can be achieved by fluid permeability of the heat conduction device 13.

The heat conduction device 13 is designed such that a process temperature of the hydrogen H2 is conducted in a directed manner to the temperature measurement.

The heat conduction device 13 is thus an envelope which is inserted in a form-fitting manner between the protective barrier 5 and the vacuum envelope 8. The heat conduction device 13 is connected in a form-fitting and/or integral manner to the protective barrier 5 and/or the vacuum envelope 8.

In order to mount the heat conduction device 13, it is inserted as a fit and connected in a form-fitting manner to the protective barrier 5 and/or the vacuum envelope 8. To facilitate installation, the base element 14 is designed as a single-piece slotted element or as a multi-part structure in a plurality of segments. In this case, “one-piece” or “single-piece” means that the base element 14 is not composed of different components, but forms a single component. In this case, “integral” means that the base element 14 is made entirely of the same material.

The base element 14 or the heat conduction device 13 is slotted. This is particularly advantageous if the gap 6 is filled with a gas, in order to be able to detect leaks between individual passages. The position of the heat conduction element 35 can be freely chosen. For example, a measurement of the coldest temperature (FIG. 1) can be made at 6 o'clock (bottom+−90°) or a measurement of the warmest temperature at 12 o'clock (top+−45°).

Due to the possible temperature differences between the process pipe 4 and the protective barrier 5, the material of the base element 14 is preferably selected such that a thermal expansion coefficient equal to or less than the smaller thermal expansion coefficient of the process pipe 4 or the protective barrier 5 is achieved.

The temperature sensor 11 can be installed without a protective envelope. In a three-envelope design of the cryogen supply system 1, one envelope can be designed as vacuum insulation or super insulation and the inner envelope can be filled with a gas. When using liquid hydrogen H2, this gas is helium He. Only helium He does not condense at the temperatures occurring in the case of liquid hydrogen H2.

By filling the gap 6 with an inert gas, a leak between all passages can be detected. The temperature sensor 11 is installed on the vacuum envelope 8. The vacuum envelope 8 is therefore not breached. It is possible to provide a plurality of heat conduction elements 35 for the spatially close installation of a plurality of temperature sensors 11.

Although the present invention has been described with reference to exemplary embodiments, it can be modified in many ways within the scope of the claims.

### REFERENCE SIGNS USED

1 Cryogen supply system
2 Consumer
3 Axis of symmetry
4 Process pipe
5 Protective barrier
6 Gap
7 Environment
8 Vacuum envelope
9 Gap
10 Temperature measuring arrangement
11 Temperature sensor
12 Protective tube
13 Heat conduction device
14 Base element
15 Axis of symmetry
16 Outside
17 Inside
18 Aperture
19 Slot
20 End face
21 End face
22 Recess
23 Recess
24 Recess
25 Recess
26 Recess
27 Recess
28 Recess
29 Recess
30 Axis of symmetry
31 Axis of symmetry
32 Region
33 Bore
34 Axis of symmetry
5 35 Heat conduction element
g Direction of gravity
He Helium/gas
H2 Hydrogen/cryogen
L Longitudinal direction
Q Heat
R Radial direction
U Peripheral direction

1. A cryogen supply system for supplying a consumer with a cryogen, comprising a process pipe through which the cryogen can be conducted, a protective barrier, in which the process pipe is received, a gap, which is provided between the process pipe and the protective barrier, a heat conduction device, which is arranged in the gap and which is designed to transfer heat from the process pipe to the protective barrier or vice versa, and a temperature sensor arranged outside the protective barrier(s) for detecting a temperature of the cryogen, wherein the temperature sensor is thermally coupled to the heat conduction device.

2. The cryogen supply system according to claim 1, wherein the heat conduction device is connected to the process pipe and/or the protective barrier in a force-fitting, integral and/or form-fitting manner.

3. The cryogen supply system according to either claim 1, wherein the heat conduction device has a slot extending along a radial direction of the heat conduction device and completely breaking through the heat conduction device.

4. The cryogen supply system according to claim 1, wherein the heat conduction device is fluid-permeable or fluid-impermeable.

5. The Cryogen supply system according to claim 1, wherein the heat conduction device has recesses which are designed as through holes or as blind holes.

6. The cryogen supply system according to claim 5, wherein the recesses are filled with a plastics material at least in part.

7. The cryogen supply system according to claim 5, wherein the recesses are arranged unevenly spaced from one another in a peripheral direction of the heat conduction device, so that at least one recess-free region is provided between two adjacent recesses.

8. The cryogen supply system according to any of claim 1, wherein the gap is gas-filled, in particular filled with helium.

9. The cryogen supply system according to claim 1, further comprising a vacuum envelope in which the protective barrier is accommodated and a gap provided between the protective barrier and the vacuum envelope.

10. The cryogen supply system according to claim 9, wherein the temperature sensor is guided through the vacuum envelope and the gap to the protective barrier.

11. The cryogen supply system according to claim 10, further comprising a protective tube in which the temperature sensor is accommodated, wherein the protective tube is led through the vacuum envelope and the gap to the protective barrier.

12. The cryogen supply system according to claim 11, wherein the protective tube is connected to the vacuum envelope in a fluid-tight manner.

13. The cryogen supply system according to claim 1, wherein the heat conduction device comprises a heat conduction element for transferring heat from the process tube to the protective barrier or vice versa.

14. The cryogen supply system according to claim 13, wherein the heat conduction device comprises a base element which carries the heat conduction element, wherein the thermal conductivity of a material from which the heat conduction element is made is greater than the thermal conductivity of a material from which the base element is made.

15. The cryogen supply system according to claim 14, wherein the base element has a bore in which the heat conduction element is received, wherein an axis of symmetry of the bore is oriented perpendicular to an axis of symmetry of the heat conduction device.
